(19) United States
(12) Patent Application Publication
(10) Pub. No.: US 2007/0174115 A1
(43) Pub. Date: Jul. 26, 2007

(54) In-store consumer-based personalized offer presentation system and method

(75) Inventors: Trieu C. Chieu, Scarsdale, NY (US); Chung-Sheng Li, Scarsdale, NY (US); Yew-Huey Liu, Yorktown Heights, NY (US); E. Michael Maximilien, Raleigh, NC (US); Jih-Shyr Yih, Yorktown Heights, NY (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/931,871

(22) Filed: Sep. 1, 2004

(51) Int. Cl. G06Q 30/00

(52) U.S. Cl. 705/14

(57) ABSTRACT

A method and apparatus for presenting customized presentation offers to a consumer having a shopping device prior to the consumer's check out in a retail environment is set forth. Using a keyword-driven rule-based method, the present invention identifies certain information regarding the consumer, items selected for purchase, retail environment and the like, and processes keywords relevant to the gathered information in view of rule types and available offers to select and prioritize for presentation to the consumer offers pertinent to the consumer's interests, locations and activities while in the store. The personalized offer presentation is made available to the consumer preferably through an in-store server communicating to the shopping device used by the consumer so as to provide the consumer with in-store offers prior to the consumer completing their shopping experience at check out.

### BACKGROUND OF THE INVENTION

1. The Field of the Invention

The present invention relates in general to a system and method for providing incentives and retail offers to customers via predetermined relational criteria. More particularly, the present invention relates to a system and method for identifying and recognizing certain characteristics and attributes of consumers and the retail items selected for purchase by the customer in relation to certain available retail offerings, relationships, particular location of the customer in the store and advertisement incentives, and thereafter, making certain offerings dynamically available to the customer while the customer is shopping.

2. Description of the Related Art It is widely known that computer systems are used and integrated with most retail related environments. Examples of such integrated systems include the use of Point of Sale (POS) devices, cash registry and inventory control devices, and various server-driven computerized systems in retail environments such as groceries, superstores and department stores. Now, it is becoming more commonplace for consumers to be offered the opportunity to use a self checkout (SCO) system, which typically comprises many of the characteristics of a POS and a traditional checkout lane with the added benefit of allowing the consumer to conduct the checkout process.

In operation, a SCO system, similar to traditional computer checkout systems (e.g., POS) using scanning technology, uses a scanner/reader to scan a Uniform Product Code (UPC) symbol (also known as the UPC symbol) on or attached to a product intended for purchase by the consumer. The consumer scans the label over the scanner/reader and the scanner/reader recognizes the UPC symbol, converts it to computer code, communicates the converted scanned UPC code for look up with a local or remote database comprising relevant product information (“product characteristics”) such as price, weight, product description, packaging dimensions and the like, for acquiring specific characteristics about the specific product. As is usually determined by the retailer, certain or all of the product characteristics for the specific product scanned are seemingly instantaneously communicated back to the SCO or POS once the information is made available following look-up in the database. Some of these product characteristics may then be displayed to or printed for the consumer at the check out lane, while other product characteristics may be used for inventory control and reordering processes depending on the retailer and the retail environment.

Once the consumer's series of item purchases is complete, the SCO may subtotal the price of all of the products (e.g., items) that were scanned using the product characteristic of price, and thereafter provide or display a subtotal amount due now, prior to discounts or coupons issued via shopping cards, frequent-purchaser programs and similar loyalty-themed schemes. Discounts may then be subtracted and the transaction completed. Afterwards, or concurrent with the completion of the transaction, often coupons are generated for the consumer's next visit.

Retailers are constantly seeking new innovations to improve people's shopping experience in order to deliver greater consumer and business values and repeat visits. It is through these loyalty-themed schemes that retailers commonly seek to encourage consumers to be loyal and frequently purchase from the specific retailer by awarding the consumer points, discounts, coupons or cash rewards. From these shopping cards, retailers in effect exchange discounts in prices for a consumer's individual purchase history. Consumers find the discounts generally beneficial and retailers find the consumer historical data to also be assistive in planning for future inventory, assessing buying frequency and identifying commonly purchased combinations of goods.

However, it is common for consumers to underutilize or even fail to redeem issued coupons on their return trip, for any one of a variety of reasons (e.g., misplaced, lost, forgotten, etc.). It is also common for certain consumers to not become familiar with the details, benefits and rules of a loyalty program. Additionally, many consumers have experienced receiving “low value” coupons at the checkout register for products and goods that compete with, are different from, or are quite unrelated to the goods they have just purchased. As a result, though such a consumer may be a member of a loyalty program with a specific retailer, that consumer may not optimally participate in the offerings of the loyalty program and only envision the loyalty program to be one of tactical benefits such as the immediate discount taken at the time of check out. Also, as the offers are normally presented during checkout and the offered product is typically not nearby (in arm's reach) the consumer cannot conveniently add it to the current purchases, nor can the consumer learn more about the product by reading the label or assessing it directly as to size, color weight etc.

Similarly, a retailer's efforts to create additional loyalty program incentives or tailored discounts and coupon offers for such a consumer will likely fail as the retailer is unable to 1) identify whether a consumer is a member of the loyalty program, 2) present and offer updated, tailored or real-time discounts to consumer, 3) know the consumer's current location in the store or 4) understand the consumer's present purchasing interests in view of the consumer's purchase history, until after the consumer has completed the transaction at checkout.

Therefore, what is needed is a method and system for retailers to provide an offer presentation method to a consumer prior to checkout which displays or offers, dynamically, a select set of promotion opportunities, incentives and relational offerings to shoppers in view of the shopper's interests and in-store activities, via a personal shopping device while in a retail environment. Such a method and system should provide a means of communication as between the shopper and the retailer, such as via a remote consumer display device in electronic communication with a server of the retailer's computer system, providing the consumer with interactive and timely suite of offerings during the consumer's shopping activity (i.e., pre-checkout). Such a method and system also should allow for the consumer to pre-specify certain preferences prior to shopping and should also provide ranked offerings to consumers in relation to their shopping behavior and location in a retail environment.

### BRIEF SUMMARY OF THE INVENTION

The present invention has been developed in response to the present state of the art, and in particular, in response to the problems and needs in the art that have not yet been fully solved by currently available retail devices and processes. Accordingly, the present invention provides an improved method and system of providing an offer presentation method to display or offer a select set of promotion opportunities, incentives and relational offerings to shoppers in view of the shopper's interests and in-store activities, via a personal shopping device while in a retail environment that overcomes many or all of the above-discussed shortcomings in the art. Additionally, the present invention also provides shoppers to be in communication with computer systems of the retailer so as to receive via electronically-initiated offerings, interactively and otherwise, timely and personalized shopping ideas, offerings and inducements.

To achieve the above, and in accordance with the invention as embodied and broadly described herein in the preferred aspects and embodiments, an in-store consumer-based personalized offer presentation system and method is provided for marketing, in a customized manner, goods to consumer while the consumer is shopping through a consumer-oriented notification device (also referred to herein as “shopping device”). Preferably the shopping device is in electronic communication with an in-store server having information related to the UPC information of goods selected for purchase by the consumer as the consumer actively shops throughout the retail store, prior to checkout.

In operation the offer presentation method and system allows the consumer to freely travel throughout the retail environment, in search of desired items (i.e., goods or products) for purchase. Once an identifiable consumer selects a good and the UPC of that consumer-selected good is read by the shopping device, information about the consumer-selected good, related promotional goods and the identified consumer are gathered and a keyword-driven rule-based engine is employed to analyze the gathered information to produce a personalized offer presentation for the identified consumer. The rule-based engine is a software-based approach having a methodology that associates keywords from or with certain of the gathered information using relational techniques so as to avoid excessive processing overhead while employing a means for most retailers to reasonably configure and update their system to accommodate the present invention. The personalized offer presentation is made available to the consumer preferably through an in-store server communicating to the shopping device the presentation offer for the consumer to consider and, preferably, act upon.

In a preferred embodiment the present invention is a method for generating personalized presentation offers for a consumer prior to the consumer's completion of a shopping event in a retail environment. The method includes: reading an information code of at least one item selected for purchase during the shopping event, via a shopping device; identifying one or more item-based keyword identifiers for each read information code and one or more consumer-based keyword identifiers for the consumer; identifying at least one active presentation offer having a keyword list from a general offer pool; assessing the one or more consumer-based keyword identifiers, the one or more item-based keyword identifiers and the at least one active presentation offer having a keyword list, in relation to one or more predetermined presentation keyword rules; and, generating a selected, dynamically ranked offer pool from available presentation offers for presentation to said consumer.

In another preferred embodiment the present invention is an information handling system comprising one or more processors, a memory accessible by the processors, a nonvolatile storage device accessible by the processors, a database of item records stored on the nonvolatile storage device, a code reader accessible by the processors, one or more viewable displays, and a presentation offer tool generating personalized presentation offers for a consumer prior to said consumer's completion of a shopping event in a retail environment, the tool including: detection logic for reading an information code of at least one item selected for purchase during the shopping event, retrieval logic for identifying and retrieving one or more item-based keyword identifiers for each read information code and one or more consumer-based keyword identifiers for the consumer; second retrieval logic for identifying and retrieving at least one active presentation offer having a keyword list from a general offer pool; processing logic for assessing the one or more consumer-based keyword identifiers, the one or more item-based keyword identifiers and the at least one active presentation offer having a keyword list, in relation to one or more predetermined presentation keyword rules; second processing logic for generating a selected offer pool from available presentation offers for presentation to the consumer, and display logic for presenting by display offers from the selected offer pool.

In a further preferred embodiment, the presentation offer system of the present invention further comprises transmission logic for sending read information codes from said shopping device to an in-store server; receiving logic for receiving item, consumer and offer information from the in-store server in response to the sent read information codes; and redemption logic for redeeming presentation offers made available to the consumer.

In yet a further preferred embodiment, the present invention is a computer program product stored on a computer operable medium for generating personalized presentation offers for a consumer prior to said consumer's completion of a shopping event in a retail environment, said computer program product comprising: means for reading an information code of at least one item selected for purchase during the shopping event, via a shopping device; means for identifying one or more item-based keyword identifiers for each read information code and one or more consumer-based keyword identifiers for said consumer; means for identifying at least one active presentation offer having a keyword list from a general offer pool; means for assessing said one or more consumer-based keyword identifiers, said one or more item-based keyword identifiers and said at least one active presentation offer having a keyword list, in relation to one or more predetermined presentation keyword rules; and, means for generating a selected offer pool from available presentation offers for presentation to said consumer.

Alternatively, the shopping device may also include the in-store server (an “integrated shopping device”) such that there is no need for wireless communication between the shopping device and the in-store server in order to present offers to the consumer. In this alternative embodiment, it is envisioned that software of the integrated shopping device would be current so as to practice the present invention. It is also envisioned that in this alternate embodiment, preferably, the integrated shopping device would likely be able to communicate with a primary server of the retailer so as to assist in checkout-related transactional activities.

A system and method as described above allows for improved consumer involvement in loyalty programs and economical benefits, while enabling retail environments to customized promotional offerings to consumers while consumers are engaged in shopping. These and other aspects, features, and advantages of the present invention will become more fully apparent from the following description and appended claims, or may be learned by the practice of the invention as set forth hereinafter. The above is merely a summary of the invention and thus contains, by necessity, simplifications, generalizations and omissions of detail; consequently, those skilled in the art will appreciate that the summary is illustrative only and is not intended to be comprehensive or limiting with regard to the invention at hand.

### BRIEF DESCRIPTION OF THE DRAWINGS

In order to better understand the manner in which the advantages, aspects and features of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a functional block diagram depiction of a retail environment having a consumer with a shopping device in communication with a retail in-store server, various goods having UPC coded labels available for purchase, in accordance with the present invention;

FIG. 1B is a closer view of a loyalty shopping card having a UPC code and various goods, previously referenced from FIG. 1, having a UPC code, in accordance with the present invention;

FIG. 1C is an operational flowchart illustrating the steps involved in presenting exemplary offers to a consumer, in a ranked manner, in accordance with a preferred embodiment of the present invention;

In FIG. 2A, a series of keyword rule types of the present invention are set forth in accordance with a preferred embodiment of the present invention;

In FIG. 2B, Offer Matching rule types of the present invention are set forth in accordance with a preferred embodiment of the present invention;

In FIG. 2C, a series of presentation rule types of the present invention are set forth in accordance with a preferred embodiment of the present invention;

FIG. 3 is an operational block diagram of the present invention, in accordance with a preferred embodiment;

FIG. 4 is a proposed implementation of the present invention, in accordance with a preferred embodiment; and,

FIG. 5 is a graphical representation of offers being displayed to a consumer via a display of the shopping device in accordance with a preferred embodiment of the present invention.

### DETAILED DESCRIPTION OF THE PREFERRED EMBODIMENTS

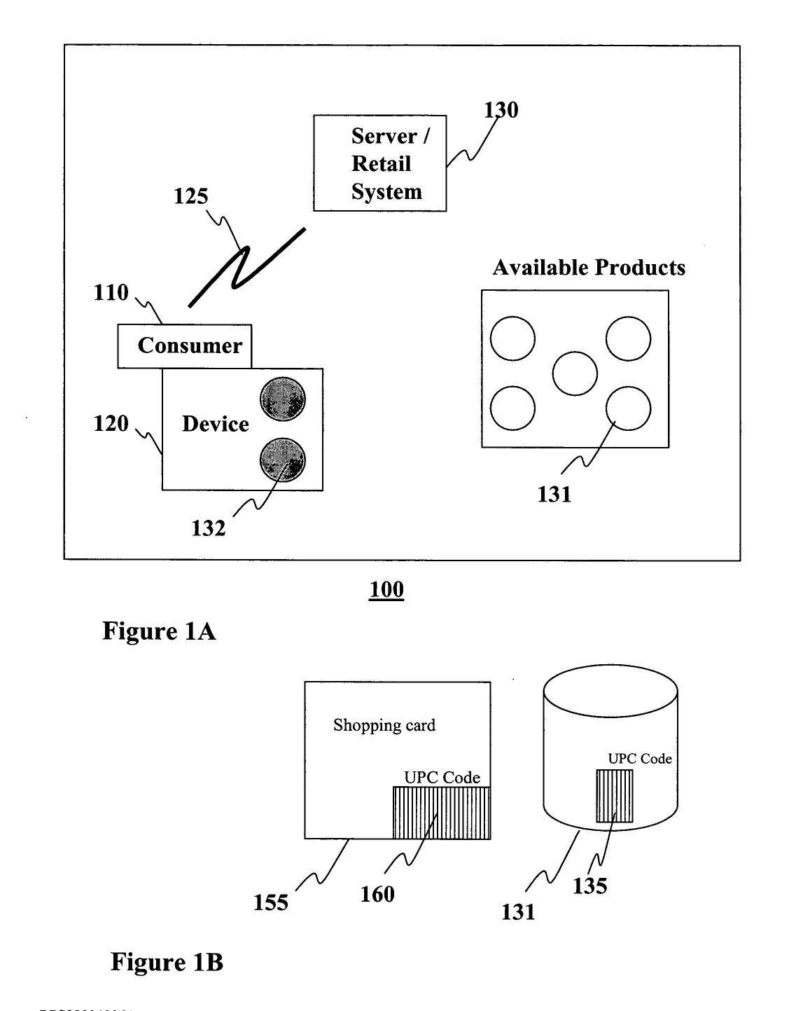

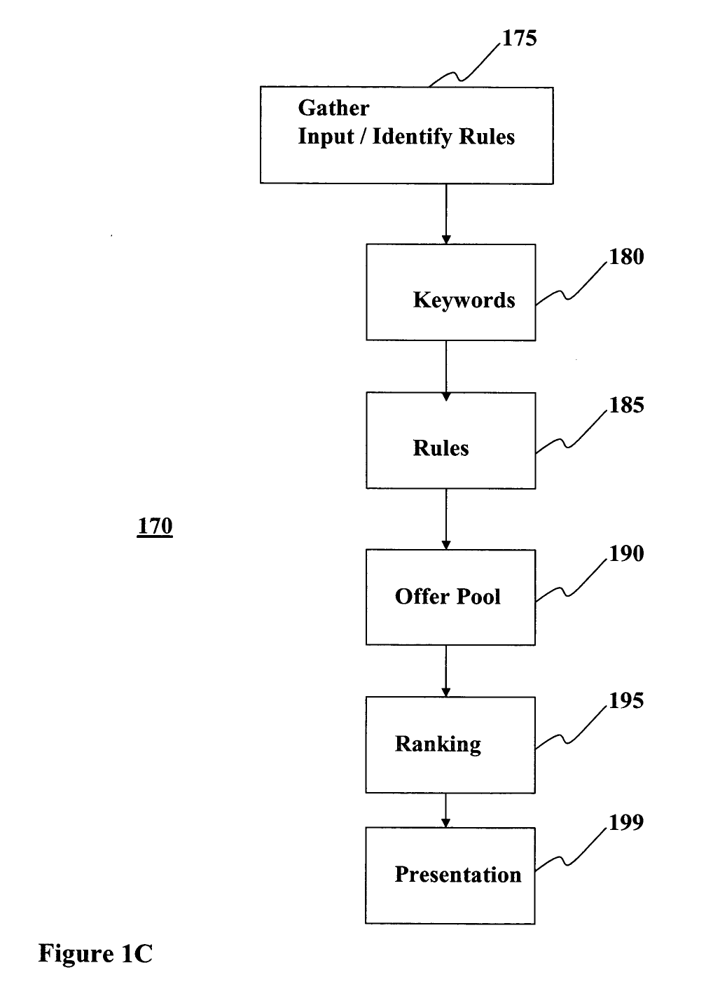

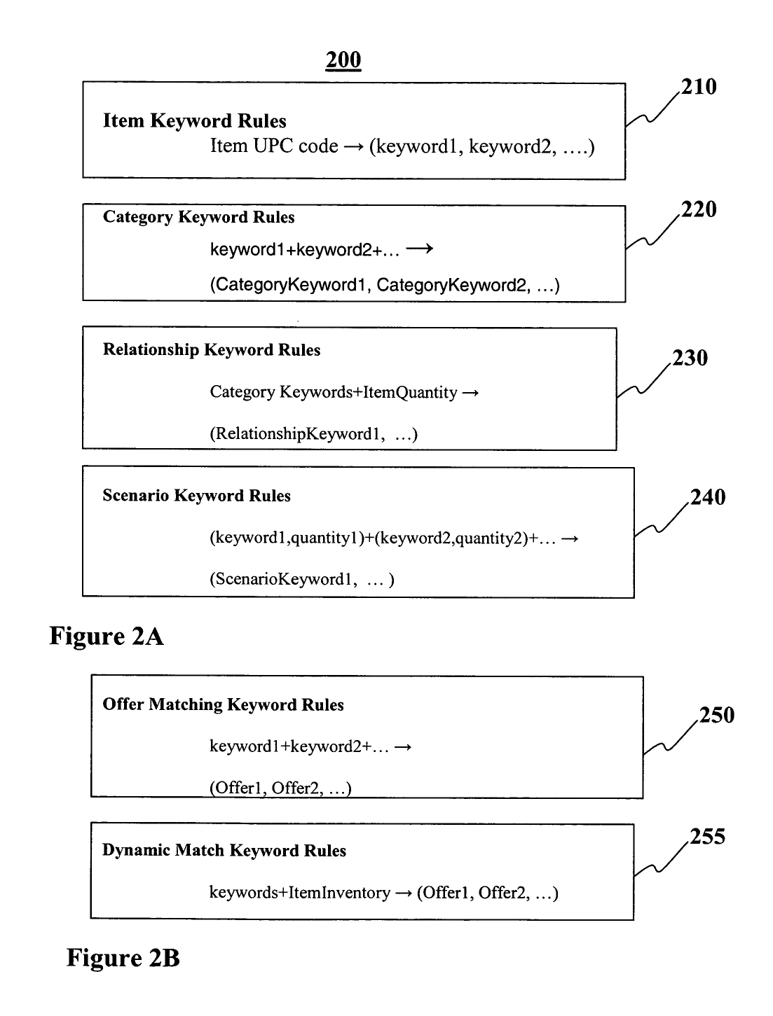

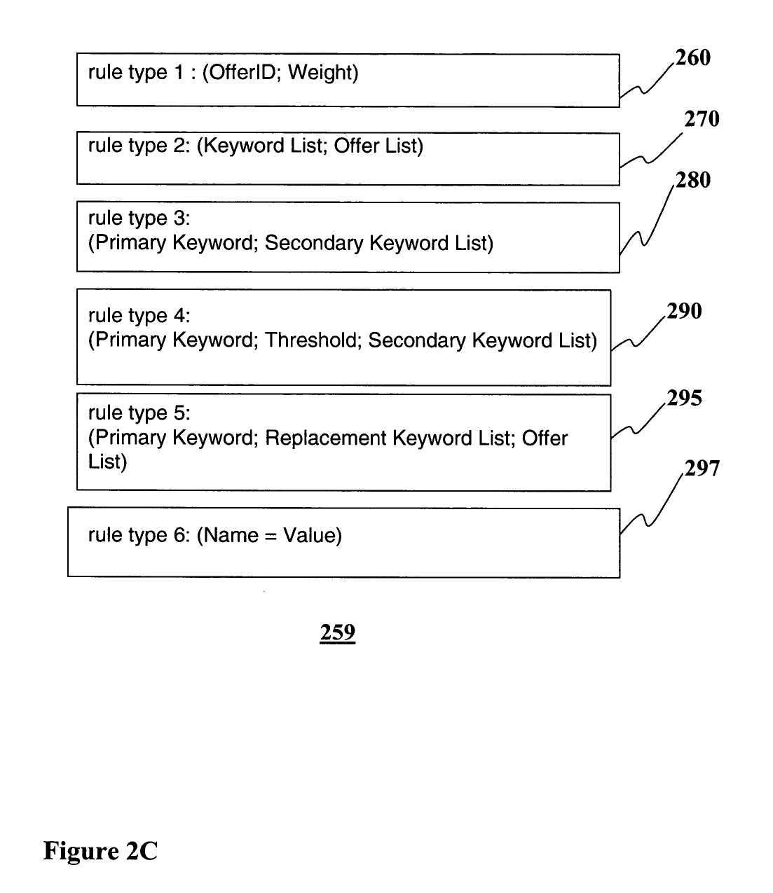

FIG. 1A is a functional block diagram depiction of a retail environment 100 having a consumer 110 with a shopping device 120 in communication 125 with a retail in-store server 130, various goods 131, 132 having UPC coded labels selected or available for purchase, respectively, in accordance with the present invention. FIG. 1B is a closer view of a loyalty shopping card 155 having a UPC code 160 and various goods 131, previously referenced from FIG. 1, having a UPC code 135, in accordance with the present invention.

A consumer 110 using the shopping device 120, may elect to first become identified to the shopping device 120. One scenario, in which a consumer 110 may become identified, is for the consumer to scan a loyalty program card, or equivalent, having a UPC code 160. Once the card 160 is scanned, the consumer becomes “identified” as the retail system 130 is able to access the identified consumer's shopping history that are inclusive of that consumer's most recent transactions. Alternative scenarios are also envisioned by the present invention to include but not be limited by those where: the consumer would become identified in order to obtain the shopping device; the consumer enters a unique keyed sequence to initiate the shopping device; the server inquires of the consumer if the consumer is a particular individual already known to the store; etc. As used in FIG. 1, goods 131 are available for purchase and have not as yet been selected by the consumer, whereas goods 132 have been selected for purchase by the consumer and have been placed into the cart 150.

The method of communication between the shopping device 120 and the server 130 is preferably of a wireless means (i.e., Bluetooth, IEEE 802.11 standard, etc.) wherein the shopping and device and server are configured to communicatively operate with one another (i.e., frequency, encryption, channel, etc.) to the exception of devices not configured to communicate with the retail environment, but in certain instances, a wired solution may be more appropriate. Such communication means 125 may be new or existing and in current use. Similarly, the shopping device may be portable or fixed without impact to the invention at hand. The server, as used herein, means any computer or computer-based system, inclusive of peripheral devices, hardware, software and communication devices, having the ability to receive, process and disseminate data

Once a consumer selects an available good 131, that good becomes a selected good 132 and the UPC coded label 135 of that selected good 132 is read by the shopping device 120. Information about the identified consumer and the selected good(s) are now available and accessible by the server; this information includes traditional product characteristic information specific to the selected good and one or more keyword(s) developed and associated by types specifically for that selected good based on a rule-based personalization scheme.

FIG. 1C is an operational flowchart 170 illustrating the steps (175, 180, 185, 190, 195, and 199) involved in presenting exemplary offers, in a ranked manner, to a consumer in accordance with a preferred embodiment of the present invention.

Various data inputs for the present invention are gathered via step 175, wherein inputs such as consumer profile, consumer's shopping history, products presently considered by consumer, products removed by consumer while shopping, quantity of product(s) acquired, location of consumer in store, consumer's shopping list, offers presently available for consumers in the retail environment, and the like, are identified. By way of example, a consumer may scan the UPC code of their loyalty program card with the shopping device such that the consumer may be uniquely identified with the retailer's computer system as UPC00000111. By way of further example, the UPC code of a product selected for purchase by the consumer is scanned via the shopping device such that the selected product may be identified with the retailer's computer system as UPC12345670. By way of additional examples, available offers may be acquired for further consideration based upon the additional inputs gathered, and the shopping device may provide the server with updated information as to the consumer's location in the store at various intervals during the shopping activity.

Upon the occurrence of identification of the one or more data inputs of step 175 by the retailer's computer system, related keywords and/or other data (hereinafter used interchangeably and collectively as “keyword”) associated with each of the identified data inputs is obtained in step 180. By way of example, following a particular consumer's scanning of the UPC code of their loyalty program card with the shopping device in step 175 (UPC00000111), one or more profile related keywords descriptive of the consumer, based on the data available to the retail system associated with the specific UPC code scanned, are obtained and determined to be “senior” and “gold customer”. For this example, the keywords “senior” and “gold customer” are the only keywords uniquely associated with the particular consumer UPC code (UPC000000111), although the keywords are not exclusive to the particular consumer UPC code and may be associated and/or descriptive of other UPC codes of other consumers. By way of further example, once the UPC code of a product selected for purchase by the consumer is scanned via the shopping device thereby identifying the selected product with the retailer's computer system as UPC12345670, one or more product related keywords descriptive of the product, based on the data available to the retail system associated with the specific UPC code scanned, are obtained and determined to yield a price value, UPC code value or similar.

Step 185 sets forth a rules-based methodology of one or more presentation rule types for creating offers from general offers available for consumers in relation to the specific input data gathered as a part of step 175 based upon keywords gathered in step 180. Available offers are identified in relation to the keywords presented and those resulting available offers meeting the predetermined presentation rule types are set forth in an Offer Pool in step 190.

The Offer Pool of step 190 is ranked in priority of presentation to the consumer in relation to the Primary Item or keyword of the Primary Item, where the Primary Item is defined to be the most recent item identified as being selected for purchase by the consumer. Once the ranking of step 190 is complete, the first ranked presentation offer is made available to the consumer via the presentation means available. Preferably, the presentation offer is displayed to the consumer via a display device on the shopping device or via a display device in proximity to and in view of the consumer so as to inform the consumer about the available offer based on the most recent item selected for purchase.

In a preferred embodiment, keywords are preferably one of two types: 1) global and 2) local. A global keyword is a keyword that may be associated with, influential to presentation offers made available to the consumer during the entire shopping session of the consumer, whereas a local keyword is associated only with the current purchased item and is unrelated and not influential to other presentation offers during the shopping session. Similarly, it is also preferred that these two categories of keywords are further categorized into keywords including: 1) item, 2) category, 3) relationship, 4) scenario and 5) profile.

These exemplary subcategories may be further described as follows:

An “item keyword” is one or more keywords that define a primary event which is generally descriptive of information about the particular item. By way of example, for a particular UPC Code on a coffee bean product, the Item Keyword may include the numeric code of the UPC code, the manufacturer's brand name, the general descriptor “coffee”, and similar. Such item keyword terms may or may not be unique to a global or local keyword description, and it is envisioned that is not necessary that the global and local keywords be identical or similar.

A “category keyword” is one or more relational keywords that derive from a set of predetermined item keywords permitting multiple identified products selected for purchased to be categorized into similar or identical categories. By way of example, for a first particular UPC Code on a coffee bean product, as described above, the Item Keyword may include the numeric code of the UPC code, the manufacturer's brand name, the general descriptor “Coffee”, and similar. For a second particular UPC Code on an instant coffee product, the Item Keyword may include the numeric code of the UPC code, the manufacturer's brand name, the general descriptor “coffee”, and similar. The Category Keywords of these two specific products would likely be identical and be identified as “Coffee”. Such category keyword terms may or may not be unique to a global or local keyword description, and it is envisioned that is not necessary that the global and local keywords be identical or similar.

A “relationship keyword” is one or more associative keywords that interrelate category keywords based on a predetermined associative reference with the original category keyword of another identified product selected for purchase. By way of example, for a first particular UPC Code on a coffee bean product, as described above, the Item Keyword may include the numeric code of the UPC code, the manufacturer's brand name, the general descriptor “coffee”, and similar. For a further particular UPC Code on a further coffee product being coffee filters, the Item Keyword may include the numeric code of the UPC code, the manufacturer's brand name, the general descriptor “coffee”, and similar. The Category Keywords of these two specific products would likely be identical and be identified as “Coffee”. The Relationship Keyword associated with the Category Keyword “coffee” based on the predetermined associative reference, for this example, is “creamer”. Such relationship keyword terms may or may not be unique to a global or local keyword description, and it is envisioned that is not necessary that the global and local keywords be identical or similar.

A “scenario keyword” is one or more keywords to set forth the primary purpose of the shopping event and is derived from a set of keywords along with the numeric occurrence (e.g., frequency of appearance) of certain of the keywords. By way of example, a consumer selects a plurality of products including pork, beans, chicken, paper plates, plastic utensils, napkins, and plastic beverage cups. For these selected items, resulting keywords having multiple occurrences include: “plastic” and “grilling”. Based on these multiple occurrences of one or more common keywords, a scenario keyword of “barbeque” is identified. Such scenario keyword terms may or may not be unique to a global or local keyword description, and it is envisioned that is not necessary that the global and local keywords be identical or similar.

A “profile keyword” is one or more keywords defining certain characteristics, description, preferences or similar data about the consumer. By way of example, a consumer may define themselves to be a “senior” or a “gourmet chef”. Similarly, the retailer may define the consumer profile keywords based on the consumer's shopping history or frequency of shopping activities, amongst other characteristics. Such profile keyword terms may or may not be unique to a global or local keyword description, and it is envisioned that is not necessary that the global and local keywords be identical or similar.

In FIG. 2A, a series of keyword rule types 200 of the present invention are set forth in accordance with a preferred embodiment of the present invention. In FIG. 2A, each keyword rule is of a particular type having a particular suite of keyword conditions or relational characteristics necessary for keyword definition and association that are independent and not duplicative of the traditional information normally associated with the UPC code of a specific good (e.g., price, weight, dimension, etc.).

In a preferred embodiment, for a particular retail setting there are one or more keyword rule types, which define what keywords are associated with other information made available or obtained as part of the in-store activities and data (e.g., scanned UPC code, category keywords, quantities, selected products, location of consumer, offers made available, etc.). Exemplary keyword rule types of the preferred embodiment include:

Item Keyword Rules 210 defines the keywords for a product selected for purchase following scanning. Preferably, though not necessarily, an Item Keyword Rule is a global rule.

Category Keyword Rules 220 define the category keywords in relation to a set of global and local keywords, wherein the set comprises global and local keywords of the newly added item selected for purchase and the global and local keywords for each of previous items selected for purchase.

Relationship Keyword Rules 230 define the relationship keywords in relation to the occurrence or appearance of a particular item or category keyword. Preferably, where the occurrence of an item was initially positive and then is reduced to zero (i.e., the item(s) was removed by the consumer prior to purchase), a Relationship Keyword Rule setting forth a suggestion for a replacement item is created (e.g., a replacement rule).

Scenario Keyword Rules 240 define the scenario keywords in relation to the occurrence or appearance of a particular item in view of the shopping event.

In FIG. 2B, Offer Matching rule types 250, 255 of the present invention are set forth in accordance with a preferred embodiment of the present invention. In FIG. 2B, each Offer Matching rule is of a particular type having a particular suite of keyword conditions or relational characteristics necessary for determining matching offers for presentation to the consumer.

In a preferred embodiment, for a particular retail setting, there are one or more exemplary Offer Matching rule types, including:

An Offer Match Rule 250 that identifies available offers for presentation to the consumer based upon keywords matching the rules of offers generally available for the consumer.

A Dynamic Match Rule 255 that is preferably made available by the retailer and identifies certain select promotional offers for presentation to the consumer based upon keywords matching the rules of offers generally available for the consumer. For example, overstocked items may be the subject of a dynamic match rule where the retailer offers certain inventory to a consumer having certain keywords occurring arising as a result of the shopping event.

In FIG. 2C, a series of presentation rule types 259 of the present invention are set forth wherein each presentation rule is of a particular type having a particular suite of presentation conditions or relational characteristics necessary for presentation that are independent and not duplicative of the traditional information normally associated with the UPC code of a specific good (e.g., price, weight, dimension, etc.). By the present invention, in addition to a consumer being able to describe themselves by their own keywords, where conditions of a rule type having a keyword are met during shopping, those associated keywords are used to describe the consumer as part of the consumer's updated information and thereby influence presentation offers to the consumer.

For example, a consumer may set forth a keyword description such a “single-parent” or “vegetarian”. Such consumer chosen keywords are incorporated into the consumer's information. Similarly, when a consumer selects a particular good for purchase (e.g., battery powered toy) and scans the item via the shopping device, the keywords associated with the UPC code of the scanned, selected good may also become additional keywords to further describe the consumer, since by selecting an item for purchase, it is likely the consumer is interested in the selected item. During the shopping activity, a consumer, in effect, continues to “define” their interest and information by the selections they undertake. Similarly, based upon the selections made with reference to predetermined presentation criteria and rules, certain offers may be made available to the consumer at varying times during the shopping experience.

In a preferred embodiment, for a particular retail setting there are one more rule Types, which influence what keywords are associated with a consumer's information and what presentation offers are made available to that consumer; are further discussed below:

Presentation rule type 1 is set forth as 260. The presentation rule type 1 rule assigns a numeric weight to an identifiable offer for the purpose of ranking for presentation. The rule type 1 rule has the exemplary form of (OfferID; Weight). The OfferID is unique to a particular offer and the Weight of that OfferID is specific to the unique OfferID. The offer associated with OfferID would be presented to the consumer based on that offer's weight or ranking as associated with the Weight.

Presentation rule type 2 is set forth as 270. The rule type 2 rule associates a list of keywords to a list of offers. The rule type 2 has the exemplary form of (Keyword List; Offer List). The Keyword List is unique to a particular offer list and comprises one or more keywords associated with a particular list of offers, such that when all keywords in the Keyword List are present (e.g., identified or associated with the scanning of the selected items, the consumer identification information, combinations thereof, or similar), the offers in the List of Offers will be made available for presentation in a predetermined manner. However, if all keywords identified in the Keyword List are not present, the offer(s) in the Offer List would not be made available for presentation.

Presentation rule type 3 is set forth as 280. The rule type 3 rule introduces additional keywords based on a single primary keyword. The rule type 3 rule has the exemplary form of (Primary Keyword; Secondary Keyword List). The Primary Keyword is unique to a particular product or consumer and the Secondary Keyword List includes a list of additional keywords that are part of an associative list, of which where a Primary Keyword were identified as being related to a scanned product, a presentation offer for other goods associated with the Secondary Keyword List may be made available for presentation.

Presentation rule type 4 is set forth as 290. The rule type 4 is similar to rule type 3, described above, with a further condition precedent of exceeding the quantity of the Primary Keyword. The rule type 4 rule has the exemplary form of (Primary Keyword; Threshold; Secondary Keyword List). The Primary Keyword is unique to a particular product or consumer and the Secondary Keyword List includes a list of additional keywords that are part of an associative list. The Secondary Keyword List under rule type 4 would be introduced only after the predetermined quantity associated with the Primary Keyword had been exceeded, as defined by Threshold.

Presentation rule type 5 is set forth as 295. The rule type 5 sets forth a rule substitution (or replacement) in the even that a consumer removes a previously selected item from purchase consideration. The rule type 5 has the exemplary form of (Primary Keyword; Replacement Keyword List; Offer List). The Primary Keyword is unique to a particular product or consumer, and the keyword is added to the consumer information when the particular product is selected for purchase. However, in the event the selected product (also referred to herein as “good”) is removed from selection by the consumer, the associated Primary Keyword is removed from the consumer's information.

Presentation rule type 6 is set forth as 297. The rule type 6 sets forth a name value pair which is used to control the dynamic execution of other rule types. The rule type 6 has the exemplary form of (Name=Value). For example, the rule type 6 may set forth a maximum number of offers that may be offered to a consumer for each new item selected for purchase; in this example, the rule type 6 may be of the form (Number of Offers Per Item=5) indicating that no more than five offers could be suggested to a consumer for each new item selected for purchase.

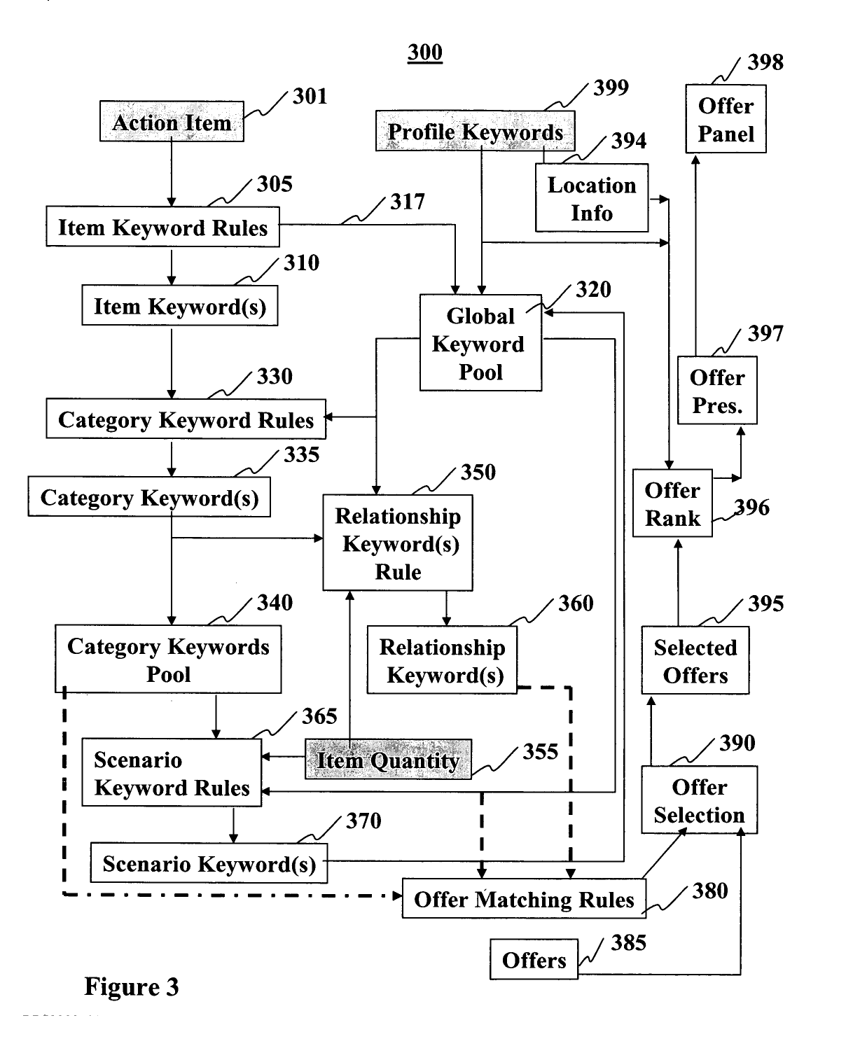

FIG. 3 is an operational block diagram 300 of the present invention, in accordance with a preferred embodiment.

In the preferred embodiment, at block 310, item keywords are generated using the item keyword rules type 305 in response to an item being added 301 to a shopping cart and read by the associated shopping device. The keywords are set forth as a list of global keywords and are added 317 to the global keyword pool 320.

Similarly, keywords identified at 310 and the list of global keywords of 320 may then be assessed as input for the category keyword rules at 330 resulting in the identification of a list of category keywords being derived at 335 using the category keyword rules as shown of 330. The list of category keywords is then added to the category keyword pool at 340 for use with other rule types. The list of category keywords at 335 and the keywords of the global keyword pool at 320 are also used as input for the relationship keyword rule type at 350. Additionally, the item quantity at 355 is a further input characteristics necessary for consideration to determine if after applying the relationship keyword rule type at 350 there may be identified any relationship keywords at 360.

Similarly, scenario keywords at 370 may be identified in reference to applying the scenario keyword rules type at 365 using item quantity values at 355, a list of category keywords from the category keyword pool at 340, and global keywords from the global keyword pool at 320. If scenario keywords are identified at 370, said scenario keywords may then be added to the global keyword pool at 320.

In the event any of the above process steps identifies or introduces an additional keyword not previously determined by earlier processing in conjunction with the rule types, the rule types are re-executed for additional processing using the new keyword(s) to determine is any additional keywords or rules are affected.

Once it is determined that the relevant rule types has been adequately executed (i.e., no new keywords are identified), the present invention in the preferred embodiment with determine relevant offers from offer rule types at 390 by assessing keywords from the list of global keywords in the global keyword pool at 320 with relationship keywords identified at 360 and category keywords from the list of category keywords in the category keyword pool at 340, in relation to the offer matching rules type(s) at 380 and the general offer pool available at 385. Via this assessment, offers are identified as being available for selection from the generally available offer pool (at 385) in relation to different combination of keywords and rule types.

In the event that any newly acquired category keywords are identified at this stage, these category keywords are added to the category keyword pool at 340 to be used at a later assessment period. Similarly, any newly acquired item keyword and scenario keyword are also added to the domain keyword pool (not identified) to be used at a future period as well. For clarification, the domain keyword pool contains keywords that affect the entire shopping session, while the category keyword pool is used only to determine the scenario keyword.

Once the selected offers available for presentation to the consumer are identified at 395 as a result of 390, preferably filtering information obtained from profile information of the consumer at 399 and location information descriptive of the consumer's location at 394, are processed to rank and prioritize the selected offers available for presentation to the consumer at 396. As a result of the ranking at 396, offers as sequenced in order of presentation at 397 and presented to the consumer via an offer panel display (preferably part of the shopping device) at 398.

In a further preferred embodiment, there are three presentation factors that affect the presentation offer priority, including: weight of offer, shopper location, and shopper preference.

The weight of the offer is an indicator of the relevant importance or value of the offer to the retail store and is likely weighted in accordance with an interest by the retailer in increase business, sales or reducing excess inventories.

For the present invention, offers available to the consumer in the offer list are dynamically changing according to the movement of a shopper around the store. The location of a shopper using a wireless shopping device is constantly tracked by a separate location server. Offers that are within a certain distance of the shopper may have higher priorities than offers that are further down the aisle. For example, purchasing a steak in the meat department may trigger an offer for steak sauce but not necessary cause such to be immediately displayed or presented to the consumer. After the shopper moves closer to the condiment aisle and the consumer's location is identified by the server, the steak sauce offer appears to the consumer.

The consumer's preference is preferably a third filtering factor in accordance with determining offer prioritization at 396. When the method of the present invention is building an offer list at 390 the consumer preference (profile keywords in the keyword rules at 399) is used to select offers that might be of interest to the shopper. Conversely, the consumer preferences are also used to filter out available offers that are not compatible or desirable to the consumer's profile. For example, an offer that sets forth a complimentary offer such as “buy two packs of hot dog buns and get 20% off a pack of hot dogs”, though available in the general offer pool, such an offer would not be shown to a consumer with a “vegetarian” preference identified in their consumer profile. Such exclusions to certain offers are set forth by the method of the present invention using rules types referred to as “exclusion rules.”

An exclusion rule has the format of “category keyword, category keyword . . . → (category keyword, weight), (category keyword, weight) . . . ” In the above example, a consumer with a “vegetarian” preference will trigger the exclusion rule-“vegetarian → (meat, −10)” indicating a negative weight and hence a non-display or selection value. Similarly, each offer has a set of category keyword associated with it. For example, a hot dog offer likely has a category keyword of “meat”. By applying the exclusion rule, this offer now has a large and negative weight of −10 and will not be shown.

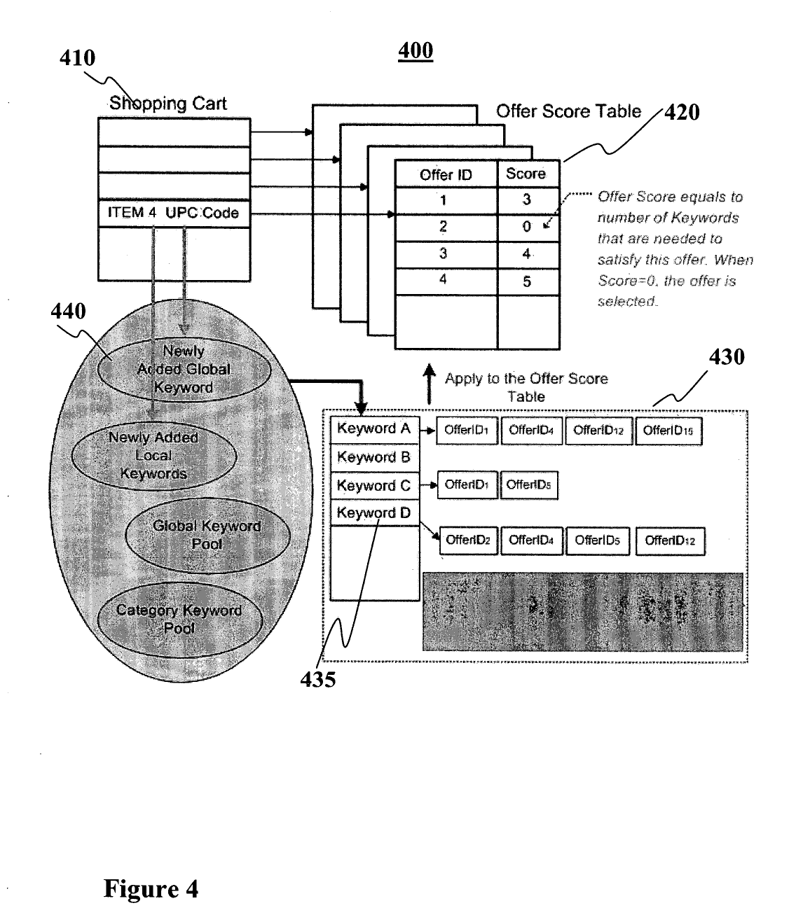

FIG. 4 is a proposed implementation 400 of the present invention, in accordance with a preferred embodiment. FIG. 4 shows the implementation 400 of the method of the present invention. In operation for this preferred implementation, each item selected for purchase (e.g., placed into the cart at 410) has an associated offer score list as part of an offer score table at 420, wherein each offer score is equal to the total minimum number of keywords necessary to satisfy a particular offer rule type. The method of the present invention identifies each keyword in the item classification keyword list at 435 and decrements the score of an offer in 420 that contains the relevant keyword by applying the said keywords at 430 to the offer score table at 420. The method of the present invention repeats the steps for each of the keywords in the item classification keyword list, to determine if any particular offer has a score value equal to zero. Where a score value for an offer equals zero, the zero value indicates that the list of keywords that are needed for this offer, as specified by an offer rule, have all been identified found and this offer is selected for consideration for presentation to the consumer. Similarly, any newly added global keyword at 440 is also rechecked against other in-cart items' offer score lists. Any offer that has a score of zero after applying a global keyword is added as a new offer for that item.

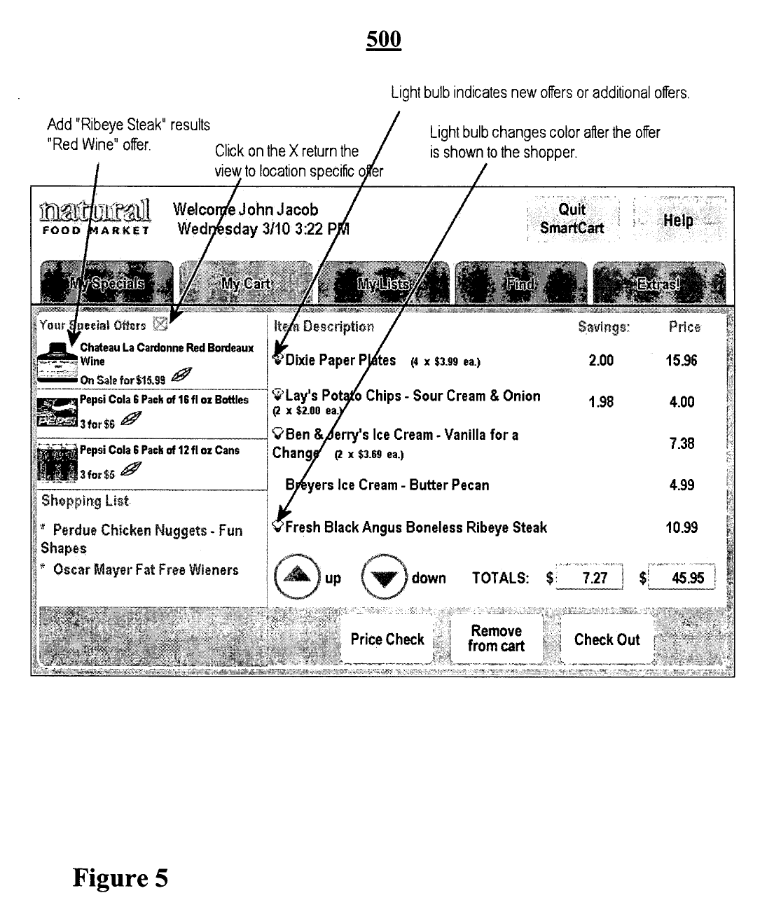

FIG. 5 is a graphical representation 500 of offers being displayed to a consumer via a display 500 of the shopping device, in accordance with a preferred embodiment of the present invention. Due to the limited display space on a wireless shopping device, it may be preferable to display offers that can occupy an entire shopping device display area. Alternatively, multiple views of a separate offer panel may be used to allow shopper to switch views between a collection of offers associate with a selected item or with the shopper's location. FIG. 5 shows a screen capture of such an implementation in a personal shopping device. It is envisioned that there are numerous variations available to display the presentation offers of the present invention to a consumer.

Advantageously, the present invention is able to fit into an inexpensive PC-based server, as the present invention employs a reasonable number of rule types and associates only keywords to categorize shopper's preference and behavior; however, the present invention is not limited to such an implementation.

One of the preferred implementations of the invention is a client application, namely, a set of instructions (program code) in a code module, which may, for example, be resident in random access memory (RAM) of the computer. Until required by the computer, the set of instructions may be stored in a another computer memory, for example, in a hard-disk drive, or in a removable memory, such as an optical disk for eventual use in a CD ROM, a floppy disk, or downloaded via the Internet or other computer network. Thus, the present invention may be implemented as a computer program product for use in a computer or computer system. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

Marketing, as used herein, includes any activity related to the marketing of goods to a consumer wherein the term is inclusive of acts such as but not limited to attempts to inform, sell, incent, promote, induce, offer, up-sell, complimentarily coordinate, competitively suggest, or similar.

A shopping device may be a traditional shopping cart with a device in communication with an in-store server, a smart cart capable of scanning or reading items selected for purchase by the consumer, a kiosk, personal digital assistants (PDAs) capable of interpreting UPC codes, or any other device or system, in whole or in part, able to scan, read or interpret coded product information (e.g., UPC or similar) and communicate with in-store computer systems to present offers to the consumer.

Input information as used herein, in addition to terms otherwise already set forth, is defined to further include, but not necessarily be limited to: items and item quantities in the shopping cart; price check and item removal; actions of a shopper scanning an item to check for item price as an indicator of interest in the item; a shopper removing an item from the cart as information concerning an offering of alternative items; shopper's in-store location; shopper profile; shopper preferences, which are supplied by the registered shopper from time to time; shopper categorizations, which are given to the shopper based on the demographic information, such as age, income, education, occupation, marital status and home address; and shopper's past shopping history.

The terms shopper, consumer and customer are intended to be of the same meaning and are used interchangeably without limitation to one another.

The term Uniform Product Code (UPC) (also known as the UPC symbol) is intended to include any machine readable or receivable code form including but not limited to UPC codes, electronic product information codes, and radio-frequency identification tags (RFID) on or attached to a product.

Many of the functional units described in this specification have been set forth as functional block or modules, in order to more particularly emphasize their implementation independence. For example, a functional block or module may be implemented as a firmware device, hardware circuit comprising custom VLSI circuits or gate arrays, off-the-shelf semiconductors such as logic chips, transistors, or other discrete devices. A functional block or module may also be implemented in programmable hardware devices such as field programmable gate arrays, programmable array logic, programmable logic devices or the like.

Functional blocks or modules may also be implemented in software for execution by various types of processors. An identified functional block or module of executable code may, for instance, comprise one or more physical or logical blocks of computer instructions which may, for instance, be organized as an object, procedure, or function. Nevertheless, the executables of an identified functional block or module need not be physically located together, but may comprise disparate instructions stored in different locations which, when joined logically together, comprise the module and achieve the stated purpose for the module.

Indeed, a functional block or module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating personalized presentation offers for a consumer prior to said consumer's completion of a shopping event in a retail environment, said method comprising:
reading an information code of at least one item selected for purchase during the shopping event, via a shopping device;
identifying one or more item-based keyword identifiers for each read information code and one or more consumer-based keyword identifiers for said consumer;
identifying at least one active presentation offer having a keyword list from a general offer pool;
assessing said one or more consumer-based keyword identifiers, said one or more item-based keyword identifiers and said at least one active presentation offer having a keyword list, in relation to one or more predetermined presentation keyword rules; and,
generating a selected offer pool from available presentation offers for presentation to said consumer.

2. The method of claim 1 where said shopping device further comprises a display.

3. The method of claim 2 further comprising presenting the offer pool of available presentation offers to the consumer via said display.

4. The method of claim 1 wherein said predetermined presentation keyword rules include item keyword rules, category keyword rules, relationship keyword rules, scenario keyword rules and offer matching rules.

5. The method of claim 4 wherein said one or more item-based keyword identifiers for each read information code comprises one or more item keywords and said one or more consumer-based keyword identifiers for said consumer comprises one or more profile keywords.

6. The method of claim 5 further comprising generating said one or more item keywords in response to said reading an information code of at least one item selected for purchase during the shopping event, and generating said one or more profile keywords from information about said consumer.

7. The method of claim 6 wherein said information about said consumer includes one or more of location information about consumer's location in said retail environment, descriptive preferences of consumer, historical shopping data about consumer, membership status of consumer in said retail environment, loyalty program information about said consumer, financial information about said consumer, and current shopping list of said consumer.

8. The method of claim 6 further comprising generating one or more category keywords, thereby categorizing multiple items selected for purchase into similar categories, in response to said generated one or more item keywords and said category keyword rules.

9. The method of claim 8 further comprising generating one or more relationship keywords in response to said generated category keywords, relationship keyword rules and quantity of an item selected for purchase.

10. The method of claim 9 further comprising generating one or more scenario keywords in response to said category keywords, said quantity of an item selected for purchase, said profile keywords and said scenario keyword rules, wherein said generated one or more scenario keywords are provided to a global keyword pool for use during the entire shopping event.

11. The method of claim 10 wherein said selected offer pool from available presentation offers is generated in response to said category keywords, said relationship keywords, said global keyword pool and said offer matching rules, in relation to said available presentation offers.

12. The method of claim 11, further comprising comparing for ranking said selected offer pool with at least one of said profile keywords and said information about consumer, and ranking said compared offer pool in a preferential order of offer display.

13. The method of claim 12 wherein the ranked selected offer pool is presented to said consumer in accordance with said preferential order.

14. The method of claim 12, wherein said ranked selected offer pool is presented to said consumer via a display on said shopping device.

15. The method of claim 13, wherein said method further comprises associating a weighted value for each profile keyword and excluding certain category keywords in response to profile keywords having a weighted negative and an exclusionary keyword rule.

16. The method of claim 4, wherein each of said predetermined presentation keyword rules is of the form of any of presentation rule types 1, 2, 3, 4, 5 and 6.

17. An information handling system comprising one or more processors, a memory accessible by the processors, a nonvolatile storage device accessible by the processors, a database of item records stored on the nonvolatile storage device, a code reader accessible by the processors, one or more viewable displays, and a presentation offer tool generating personalized presentation offers for a consumer prior to said consumer's completion of a shopping event in a retail environment, said tool including: detection logic for reading an information code of at least one item selected for purchase during the shopping event, retrieval logic for identifying and retrieving one or more item-based keyword identifiers for each read information code and one or more consumer-based keyword identifiers for said consumer; second retrieval logic for identifying and retrieving at least one active presentation offer having a keyword list from a general offer pool; processing logic for assessing said one or more consumer-based keyword identifiers, said one or more item-based keyword identifiers and said at least one active presentation offer having a keyword list, in relation to one or more predetermined presentation keyword rules; second processing logic for generating a selected offer pool from available presentation offers for presentation to said consumer, and display logic for presenting by display offers from said selected offer pool.

18. The system of claim 17 further comprising transmission logic for sending read information codes from said shopping device to an in-store server; receiving logic for receiving item, consumer and offer information from said in-store server in response to said sent read information codes; and redemption logic for redeeming presentation offers made available to said consumer.

19. A computer program product stored on a computer operable medium for generating personalized presentation offers for a consumer prior to said consumer's completion of a shopping event in a retail environment, said computer program product comprising: means for reading an information code of at least one item selected for purchase during the shopping event, via a shopping device; means for identifying one or more item-based keyword identifiers for each read information code and one or more consumer-based keyword identifiers for said consumer; means for identifying at least one active presentation offer having a keyword list from a general offer pool; means for assessing said one or more consumer-based keyword identifiers, said one or more item-based keyword identifiers and said at least one active presentation offer having a keyword list, in relation to one or more predetermined presentation keyword rules; and, means for generating a selected offer pool from available presentation offers for presentation to said consumer.

20. An in-store personalized presentation offer system, comprising a computer program product stored on a computer operable medium for generating personalized presentation offers for a consumer prior to said consumer's completion of a shopping event in a retail environment, said computer program product comprising: means for reading an information code of at least one item selected for purchase during the shopping event, via a shopping device; means for identifying one or more item-based keyword identifiers for each read information code and one or more consumer-based keyword identifiers for said consumer; means for identifying at least one active presentation offer having a keyword list from a general offer pool; means for assessing said one or more consumer-based keyword identifiers, said one or more item-based keyword identifiers and said at least one active presentation offer having a keyword list, in relation to one or more predetermined presentation keyword rules; means for generating a selected offer pool from available presentation offers for presentation to said consumer; and means for displaying one or more offers from said selected offer pool.
